(19) United States
(12) Patent Application Publication
(10) Pub. No.: US 2026/0357658 A1
(43) Pub. Date: Nov. 12, 2026

(54) IN-LINE SPEED-UP GEAR BOX AND SYSTEM FOR INCREASED COMPRESSOR PERFORMANCE IN A BLASTHOLE DRILL RIG

(71) Applicant: SANDVIK MINING AND CONSTRUCTION USA, LLC, Alachua, FL (US)

(72) Inventors: Arnold LAW, Gainesville, FL (US); Jon NESS, Lakeville, MN (US); John WAGNER, Dubuque, IA (US)

(21) Appl. No.: 19/664,615

(22) Filed: Apr. 30, 2026

Related U.S. Application Data
(60) Provisional application No. 63/797,307, filed on Apr. 30, 2025.

(51) Int. Cl. E21B 7/02

(52) U.S. Cl. CPC E21B 7/022; E21B 7/025

(57) ABSTRACT

A speed-up gearbox for a vehicle including an input shaft operatively connected to a 1500 RPM electric motor, an output shaft operatively connected to an 1800 RPM air compressor, and a gear assembly system configured to increase the rotational speed from the input shaft to the output shaft. A mining vehicle incorporating the speed-up gearbox is also provided.

### RELATED APPLICATION DATA

This application claims priority of U.S. Provisional Application No. 63/797,307, filed Apr. 30, 2025, which the entirety thereof is incorporated herein by reference.

### TECHNICAL FIELD

The present disclosure relates to a speed-up gear box and system to increase the speed of an air compressor of a vehicle, for example, a blasthole mining drill rig.

### BACKGROUND

Mining vehicles may be continuously connected to the electrical network of a mine. Accordingly, the mining vehicles can have an electric motor, and typically an electric motor with a constant rotation rate. The power required by the work phase may then be adjusted, and the electric motor obtains the electric current and load power defined by the energy consumption of the work phase from the electrical network of the mine. Further, the movement of the mining vehicle is then typically bound to the electrical network or at least to the cable connected.

Thus, electric power blasthole drills use electricity from the grid of the area they are located. One main characteristic of grid power is the frequency of the alternating current (AC). More than half of the world operates at 50 HZ, while 60 Hz is the predominant AC frequency in the western hemisphere.

An innate physical fact for 4 pole induction motors is the speed of rotation, which is theoretically 30 times the AC frequency. Thus, 50 Hz 4 pole electric motors turn at a theoretical speed of 1500 rpm, while 60 Hz motors turn at 1800 rpm.

An air compressor will turn at the motor speed. A 50 Hz motor turning at 1500 rpm results in 1200 CFM (cubic feet per min) for a 1450/350 compressor. Thus, a 50 Hz driven air compressor will operate at 83% of the capacity of a 60 Hz driven air compressor. Accordingly, the performance of a 50 Hz electric motor compressor is less than the performance of a 60 Hz electric motor.

As set forth above, since there are different electrical frequencies typically used at mines, depending on what location in the world the mine site is at, there is a need to provide an easily increased rotation speed for a 50 Hz driven air compressor such that the 50 Hz driven compressor will perform at the same rate as a 60 Hz driven air compressor.

### SUMMARY

For 50 Hz motors standard hydraulic pump drive gear ratios compensate for the slower motor rpm. With the present system no change to the hydraulics due to 50 Hz motors is needed except for the hydraulic pump drive gear ratio. The present in-line speed-up gear box and system increases the performance of, for example, a blasthole drill such as a DTH (down-the-hole) drill or a rotary drill, in 50 Hz countries, especially at high altitude.

One aspect of the present disclosure is to increase the rotation speed of the air compressor to 1800 rpm to obtain rated performance using a 50 Hz motor.

Another aspect of the present is to provide a system that can accommodate different motor and air compressor sizes. For example, the system is designed not to use a speed-up gear box for a 60 HZ motor operation, but to add the speed-up gear box for 50 Hz electric motor operation. This keeps mechanical changes between the two speeds at a minimum.

In an embodiment there is provided a speed-up gearbox for a vehicle includes an input shaft operatively connected to a 1500 RPM electric motor, an output shaft operatively connected to an 1800 RPM air compressor, and a gear assembly system configured to increase the rotational speed from the input shaft to the output shaft.

In another embodiment there is provided a mining vehicle having a base, an electric motor mounted on the base, the electric motor including an input shaft, an air compressor mounted on the base, the air compressor including an output shaft; and an in-line speed up gear box disposed between the electric motor and the air compressor and configured to increase the rotational speed from the input shaft to the output shaft.

The foregoing summary, as well as the following detailed description of the embodiments, will be better understood when read in conjunction with the appended drawings. It should be understood that the embodiments depicted are not limited to the precise arrangements and instrumentalities shown.

### BRIEF DESCRIPTION OF THE DRAWINGS

FIG. 1 is a side perspective view of an electric powered blasthole rig.

FIG. 2 is a side perspective of a known 60 Hz motor and air compressor coupling system.

FIG. 3 is a top view of the 60 Hz system of FIG. 2.

FIGS. 4A and 4B are detailed views of the connection arrangement between the 60 Hz motor and the air compressor shafts of FIG. 2 FIG. 5A is a side perspective of a 50 Hz motor and speed-up gear box system of the present disclosure and FIG. 5B is an enlarged view thereof. FIG. 5C is a side view without the speed-up gear box.

FIG. 6 is a top view of the 50 Hz system of FIG. 5A and FIG. 6B is an enlarged side view

FIG. 7 is a detailed view of the connection arrangement between the 50 Hz motor and air compressor shafts.

FIG. 8A is a perspective view the speed-up gear box system of the present disclosure.

FIG. 8B is a top, cross-sectional view of the speed-up gear box system of FIG. 8A.

FIG. 9 is a perspective cross-sectional view of the speed-up gear box.

FIG. 10 is a side cross-sectional view of the speed-up gear box.

FIG. 11 is an exploded view of the speed-up gear box.

FIG. 12 is an enlarged view of the sealing details of the speed-up gear box.

FIG. 13 is a perspective view of the speed-up gear box.

FIG. 14 is an exploded view of the gear arrangement of the speed-up gear box.

FIG. 15 is a top view of the base for the speed-up gear box system of the vehicle of the present disclosure.

### DETAILED DESCRIPTION

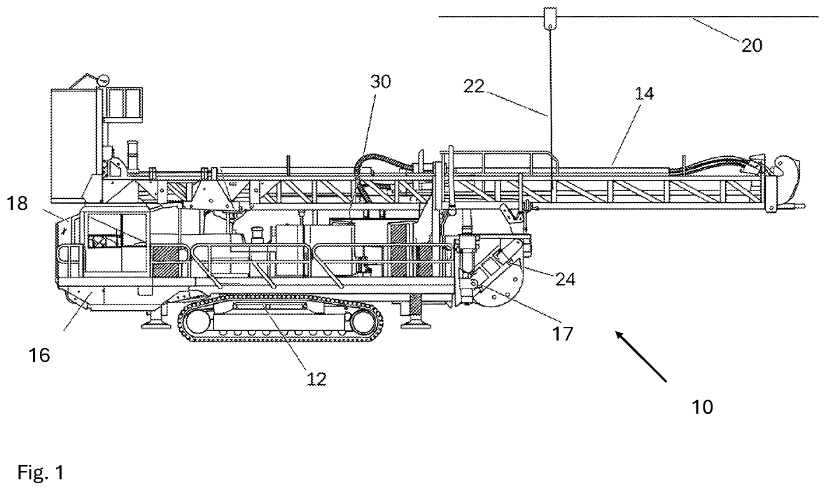

As shown in FIG. 1, a mining vehicle 10, such as an electric blasthole drill rig, includes a deck or carriage 12 and a mast 14 mounted at a first end 16 of the carriage. As is known, mast 14 is movable between a horizontal, stored position and a vertical, operable position, where the work devices or drilling components carried thereon are operable. A cab 18 is also provided at first end 16. A power cable 22 held by a reel 24 is positioned at the other end 17 of the carriage 12. The mining vehicle includes a drive assembly 30.

When the mining vehicle 10 is at a work site, its mining work device and systems are driven mainly by electrical energy obtained from an external electrical power supply network 20. The electrical network 20 is typically a three-phase alternating current network. The mining vehicle 10 may be connected to the electrical network 20 with power cable 22.

Mining vehicles may be continuously connected to the electrical network of the mine. Accordingly, the mining vehicles have an electric motor, and typically an electric motor with a constant rotation rate. The power required by the work phase may then be adjusted, and the electric motor obtains the electric current and load power defined by the energy consumption of the work phase from the electrical network of the mine. Further, the movement of the mining vehicle is then typically bound to the electrical network or at least to the cable connected.

The air compressor in a blasthole drill rig plays a crucial role in the drilling process. Some functions include powering the drilling device, for example, the air compressor provides the necessary power to a DTH hammer, enabling it to penetrate rock formations. However, the compressed air is mainly used to remove or flush drill cuttings from the hole. This helps keep the drill bit clean and reduce friction. These and other functions make the air compressor an essential component for efficient and effective drilling operations.

Vehicle 10 includes other conventional components, which will not be discussed further herein. It should also be appreciated that other types of vehicles are contemplated being powered by the present power supply and the present disclosure is not limited to mining vehicles.

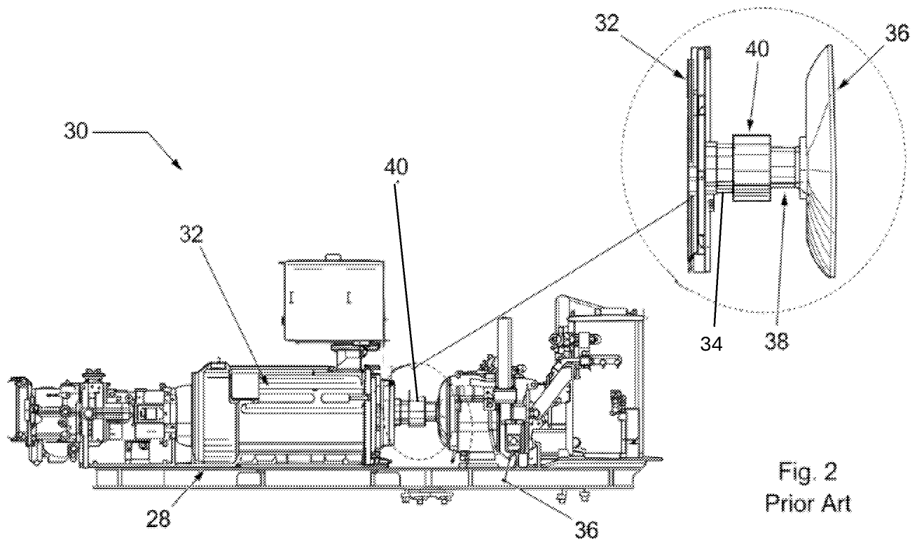

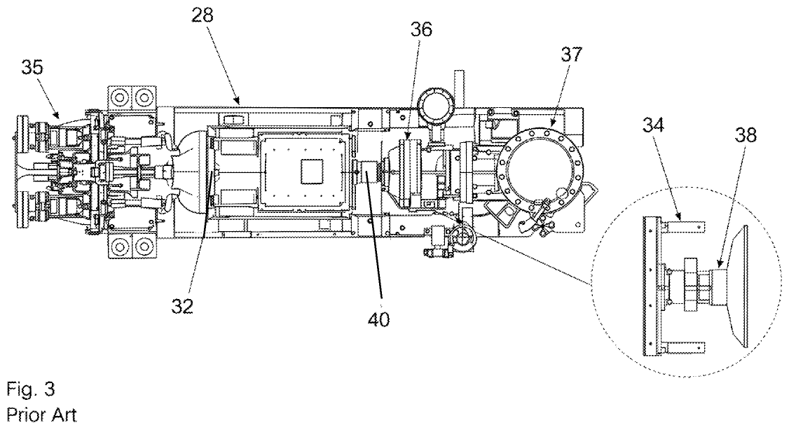

Referring to FIGS. 2-4B, as is known, the drive assembly 30 can include either a 50 Hz or a 60 Hz electric motor 32 and air compressor 36. However, the 50 Hz will provide a lower, less desirable volume output than the 60 Hz.

Standard components such hydraulic pumps 35 and air tank 37 are provided.

As shown in more detail in FIGS. 2-4A, a shaft 34 of the electric motor 32 is directly connected to the air compressor's shaft 38 by a flexible, elastomeric coupling 40. This direct coupling 40 ensures efficient power transfer from the motor to the compressor, minimizing energy loss.

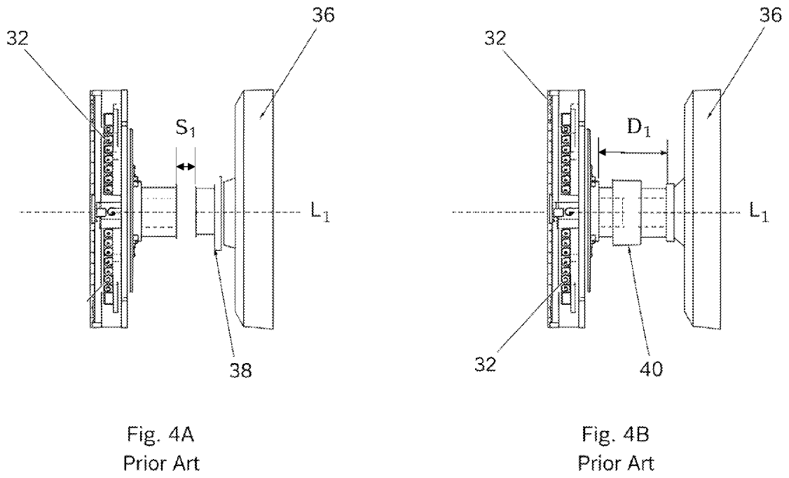

Shaft 34 and shaft 38 are aligned along axis L₁ as shown in FIG. 4A. The ends of shafts 34 and 38 are separated by a distance S₁. S₁ is determined by the coupling 40. As shown in FIG. 4B, direct coupling 40 has a width D₁. D₁ is also determined by the coupling 40. However, with such a known arrangement there is not the ability to increase the output of a 50 Hz motor. The 50 Hz would have to be swapped out for a 60 Hz for increased output as discussed above.

As discussed supra, the present compact speed-up gear box can increase the speed of the air compressor to 1800 RPM or more as required to obtain the necessary performance with a 50 Hz motor. As will be described further herein, the addition of the gear box to the 50 Hz machine can be done without a major redesign.

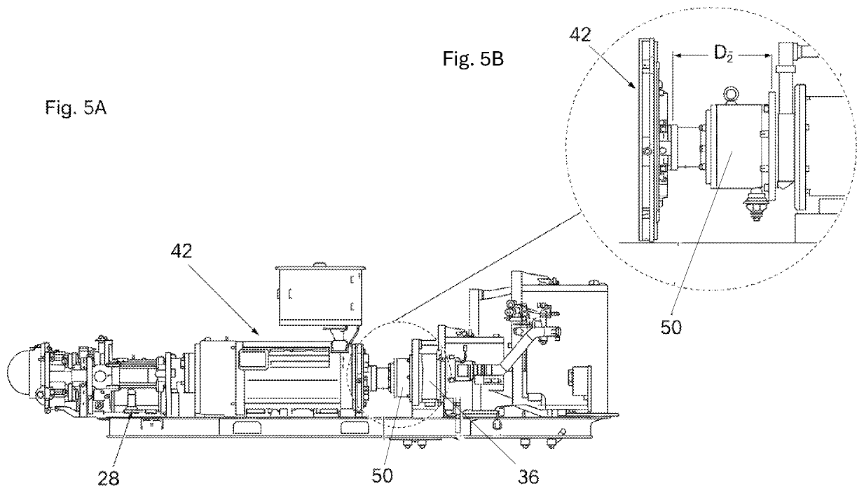

Referring to FIGS. 5A-6, a 50 Hz motor 42 is coupled to the air compressor 36 via speed-up gear box 50. Motor 42 turns at 1500 RPM. Gear box 50 enables the compressor 36 to turn at 1800 RPM (as if it was connected to a 60 Hz motor). Thus, gear box 50 enables a gear ratio 1.2 to 1 speed-up.

A 1 to 1.2 gear ratio means that for every 1 rotation of the input gear, the output gear completes 1.2 rotations. Thus, this type of gear ratio is used to increase the speed of the output gear relative to the input gear. In other words, with a 1 to 1.2 gear ratio, the output gear rotates faster than the input gear. Specifically, if the input gear rotates at 1500 RPM, the output gear will rotate at 1800 RPM. Using a 1 to 1.2 gear ratio gearbox between a 1500 RPM electric motor and an 1800 RPM air compressor ensures that the compressor operates at the desired higher speed.

As shown in FIG. 5B, speed-up gear box 50 has a width D₂, which is larger than width D1 of the known coupling 40.

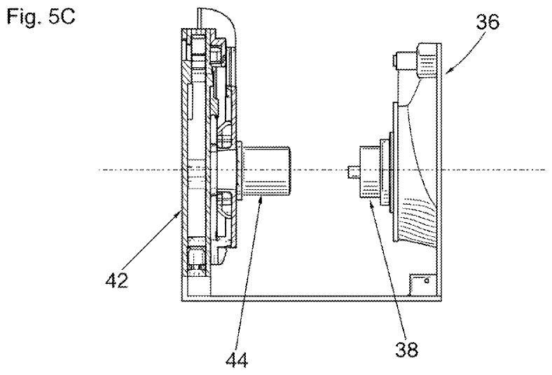

Referring to FIG. 7, shaft 44, which is an input shaft operatively connected to the 1500 RPM, 50 Hz electric motor 42, rotates about axis L₂. As discussed supra, shaft 38 of compressor 36 acts as an output shaft that rotates about axis L₁ at 1800RPM. Axes L₁ and L₂ are spaced by a distance Dₒₛ. Dₒₛ should be as small as possible for ease of interchangeability between 50 and 60 Hz motors, because if larger, more space is needed for mounting numerous components.

Referring to FIGS. 5C and 7, it can be seen that from the side view both shafts 44 and 38 are vertically aligned. However, it can be seen in FIG. 7, which is a top view, the shafts 38 and 44 are horizontally offset (Dₒₛ). The gears would not engage unless the gears were spaced by Dos.

The end of the shafts 44 and 38 are spaced by an appropriate distance S₂ so as to accommodate speed-up gear box 50. S₂ should be as small as possible and as close to S₁ as possible for the above reasons. The same applies to D1 and D2. This enables as much as a compact design as possible. For example, S₂ can be compact design.

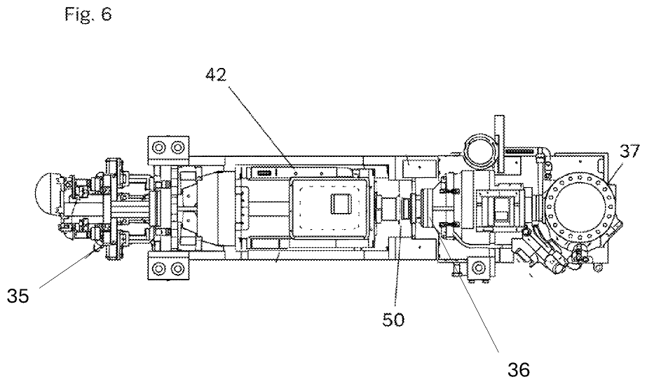

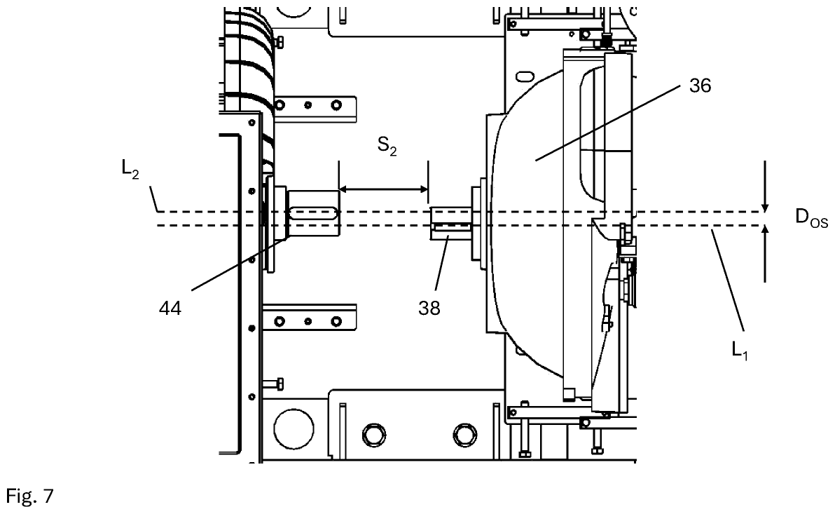

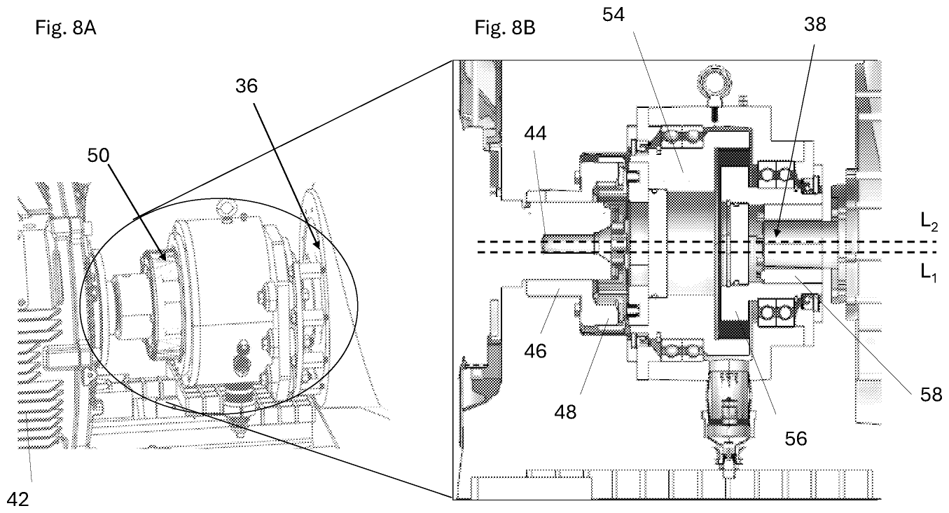

The speed-up gear box 50 will be described further with reference to FIGS. 8A and 8B. A flexible coupler 48 is connected to the end of motor shaft 44 such that the shaft extends through flange 46. Referring further to FIGS. 9, 11 and 12, coupler 48 is in two parts, flange 46 and coupling 47. Teeth 45 of coupling 47 are surrounded by flexible elastomeric inserts 49. This arrangement allows for misalignment/offset of the two shafts 38 and 44 as described above.

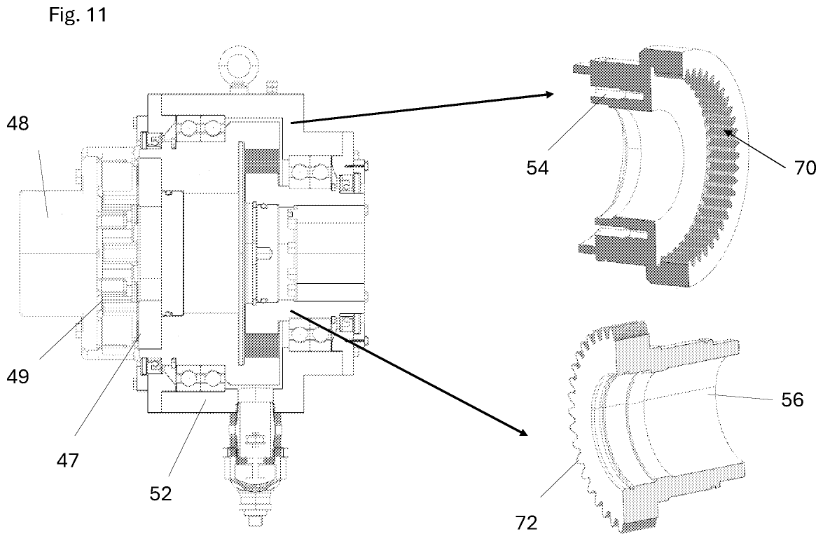

Speed-up gear box 50 includes a housing 52. Disposed within housing 52 are a ring gear 54 and a spur gear 56. As shown in FIG. 11, circular ring gear 54 has teeth 70 on its inner circumference. The ring gear 54 is placed to allow the spur gear 56 to rotate within it. Spur gear 56 has teeth 72 which are straight and parallel to axis L₁ that mesh with teeth 70 of ring gear 54.

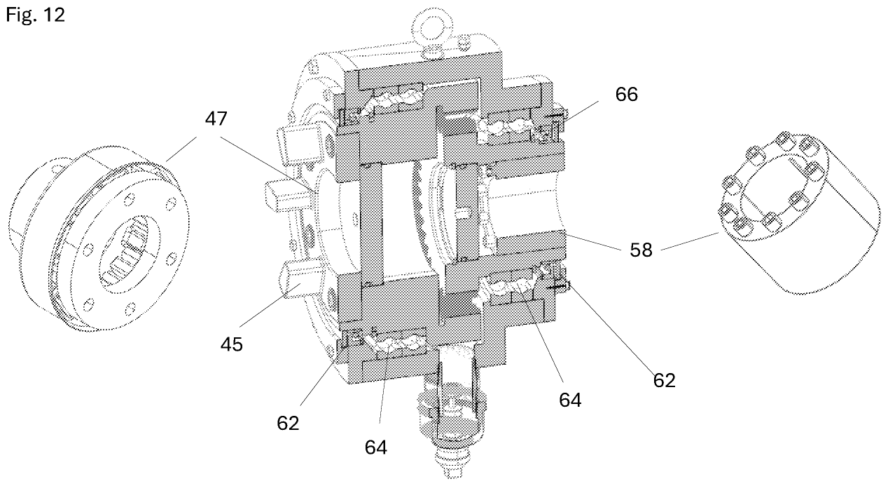

Referring to FIG. 12, a shaft clamp 58 is located within flange 60 of spur gear 56. Clamp 58 is an internal/external clamp split ring that locks shaft 38 to spur gear 56.

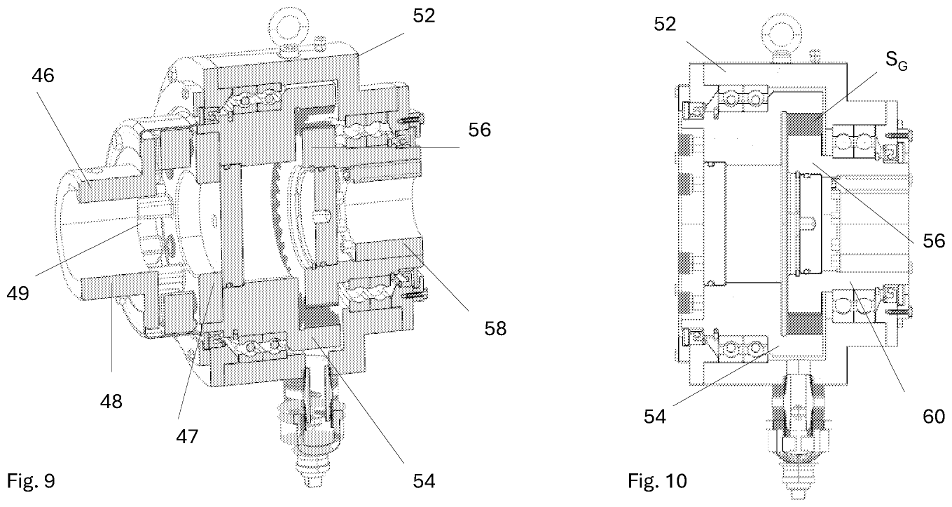

Referring back to FIG. 8B and FIG. 10, and as described above, shafts 44 and 38 are horizontally offset. As can be seen in FIG. 8B, which is a top view, as shown at the bottom of the spur gear the teeth of spur gear 56 are engaged with the teeth of ring gear 54. However, at the top the gears are spaced by a distance SG. However, as shown in FIG. 10, which is a side view, the space So extends on both top and bottom of the figure.

Ring gear 54 turns at 1500 rpm for 50 Hz. Further, ring gear 54 has more teeth than spur gear 56, for example, 20% more. Spur 56 rotates at 1800 rpm. Thus, the ratio of teeth/gear is 1.2 to 1, further, to as discussed above.

Referring again to FIGS. 10 and 12, ring gear 54 and spur gear 56 are positioned within housing 52 via bearings 64. As known, ball bearings 64 have different sizes as needed.

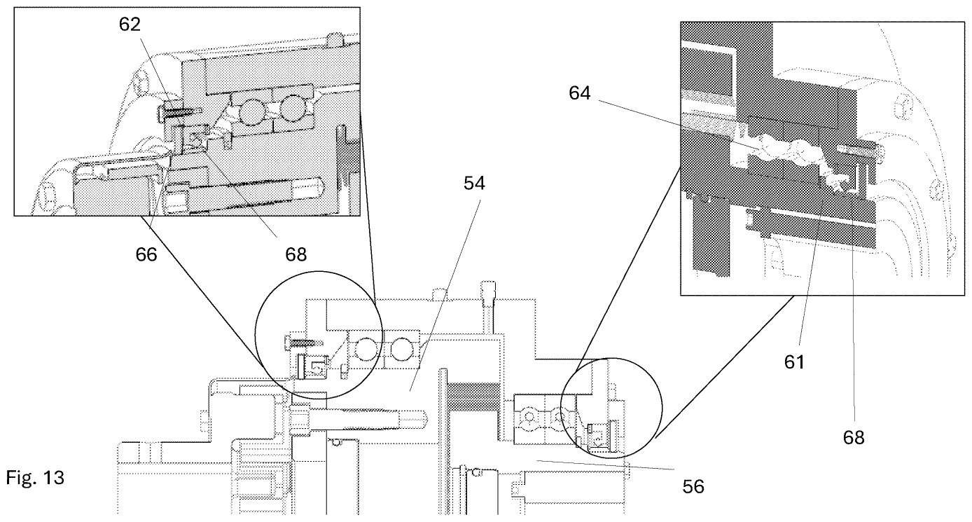

Additionally, as shown in detail in FIGS. 12 and 13, additional components are provided to hold components in place. Snap rings are provided to keep the components of the assembly from sliding. A V-shaped oil seal 62 is provided between housing 52 and gears 54 and includes a lip 61 that engages steel wear surface 68. Shims 63 are positioned between seal 62 and housing 52. Removal of a shim enables lip 61 of seal 62 to be moved from a worn position to a new position on wear surface 68.

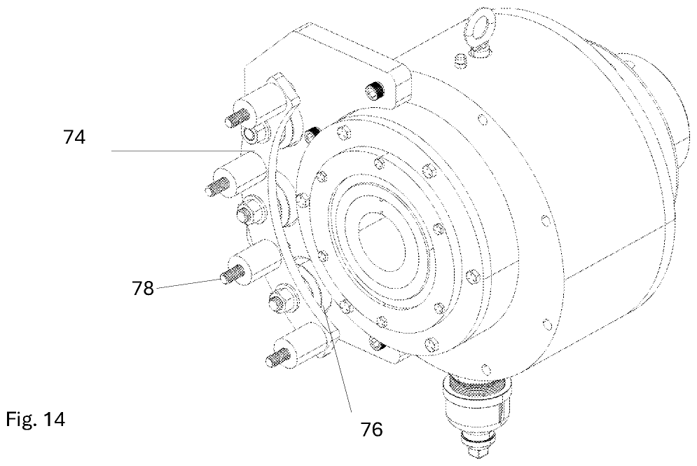

Referring to FIG. 14, a flexible mounting plate 74 is provided for mounting the gear box 50 to the compressor 36. Plate 74 includes bolts 78 engage gear box 50. Elastomer rings 76 are disposed between mounting plate 74 and the compressor for a flexible mounting therebetween.

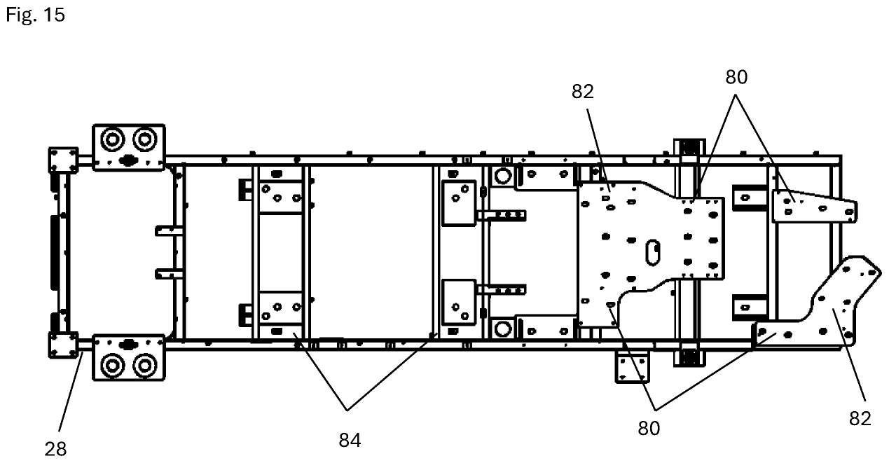

The entire assembly, including the electric motor and air compressor, is mounted on a common base or frame 28. This ensures stability and alignment, reducing vibrations and wear. Referring to FIG. 15, in order to enable the change from a 50 Hz motor and gear box, a 60 Hz motor, and different compressor sizes mounting base 28 has a plurality of mounting plates 80, 84. Mounting plates 84 are positioned to accommodate the motor and mounting plates 80 accommodate the compressor 36. Plates 80 have a variety of holes 82 positioned in particular patterns such that the same base 28 can accommodate the different motors and compressors. For example, a 1450/350 and a 2000/100 compressor. Thus, base 28 can accommodate four different configurations, a 60 Hz electric motor and a 1450 CFM/350 PSI compressor, a 60 Hz electric motor and a 2000 CFM/100 PSI compressor, a 50 Hz electric motor and a 1450 CFM/350 PSI compressor, and a 50 Hz electric motor and a 2000 CFM/100 PSI compressor.

Although the present embodiment(s) have been described in relation to particular aspects thereof, many other variations and modifications and other uses will become apparent to those skilled in the art. It is preferred therefore that the present embodiment(s) be limited not by the specific disclosure herein, but only by the appended claims.

What is claimed is:

1. A speed-up gearbox arranged for use between an electric motor and an air compressor of a vehicle, comprising:
a housing;
an input shaft rotatably supported in the housing and configured to be operatively coupled to the electric motor;
an output shaft rotatably supported in the housing and configured to be operatively coupled to the air compressor; and
a gear assembly disposed within the housing and operatively connecting the input shaft to the output shaft,
wherein the gear assembly is configured to increase a rotational speed of the output shaft relative to a rotational speed of the input shaft.

2. The speed-up gearbox of claim 1, wherein the gear assembly comprises an internal ring gear and a spur gear disposed within the internal ring gear.

3. The speed-up gearbox of claim 2, wherein the internal ring gear is directly coupled to the input shaft and the spur gear is directly coupled to the output shaft.

4. The speed-up gearbox of claim 2, wherein a ratio of teeth between the internal ring gear and the spur gear is approximately 1.2:1.

5. The speed-up gearbox of claim 1, wherein the input shaft and the output shaft are vertically aligned and horizontally offset relative to one another.

6. The speed-up gearbox of claim 1, wherein the input shaft is operatively connected to a 1500 RPM electric motor, and the output shaft is operatively connected to an 1800 RPM air compressor.

7. The speed-up gearbox of claim 1, further comprising a flexible coupling connected to the input shaft, the flexible coupling configured to accommodate misalignment between the input shaft and the output shaft.

8. A mining vehicle comprising:
a base;
an electric motor mounted on the base;
an air compressor mounted on the base; and
the speed-up gearbox of claim 1 disposed between the electric motor and the air compressor.

9. The mining vehicle of claim 8, wherein the electric motor is a 50 Hz electric motor and the speed-up gearbox increases a rotational speed of the air compressor to substantially match operation with a 60 Hz electric motor.

10. The mining vehicle of claim 8, wherein the input shaft is operatively connected to a 1500 RPM electric motor, and the output shaft is operatively connected to an 1800 RPM air compressor.

11. A method of increasing air compressor performance in a mining vehicle, comprising:
operatively coupling an electric motor to an air compressor through an in-line speed-up gearbox; and
increasing a rotational speed of the air compressor relative to the electric motor using a gear ratio greater than 1:1,
wherein the air compressor operates at a speed substantially equivalent to operation with a higher-frequency electric motor.
